(19) United States
(12) Patent Application Publication
(10) Pub. No.: US 2016/0141898 A1
(43) Pub. Date: May 19, 2016

(54) CELL PHONE CHARGING SYSTEM

(71) Applicant: Ricot Riphin, Youngsville, NC (US)

(72) Inventor: Ricot Riphin, Youngsville, NC (US)

(21) Appl. No.: 14/540,045

(22) Filed: Nov. 13, 2014

(51) Int. Cl. H02J 7/00

(52) U.S. Cl. CPC H02J 7/0044

(57) ABSTRACT

The present invention is a cell phone charger built into the back of the phone or the back of the cell phone case for easy access and use without opening up the phone to charge the battery.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to cell phone charging. In particular, it relates to self-contained cell phone charging.

2. Description of Related Art

The proliferation of cell phones means that virtually everyone now has a cell phone. With the introduction of smartphones, phone power consumption has increased so dramatically that it is frequently the case a phone will not stay charged for an entire day. It is not infrequent that one can see people searching for a place to plug in a phone. This is especially true at airports and other transportation and travel locations.

While charging equipment is cheap and readily available, it is common that in addition to the problem of charging the phone, forgetting to bring a charger and cord happens frequently. This happens often enough that kiosks and stores in airports and other locations selling chargers and cords are now available and do a brisk business. In addition, even when traveling by car it is easy to forget the car charger and end up with an uncharged phone.

One approach to solving this problem is the availability of portable battery chargers that contain a replaceable battery, and/or are rechargeable themselves. However, these devices suffer from the same problem that one has to remember to bring the device in order to use it. Another approach is to equip the cell phone with a solar charger. This has the obvious problem of not working indoors or at night. Accordingly, it is frequent that phones completely discharge, leading to missed calls, missed emails and loss of other functions of today's smartphone.

### BRIEF SUMMARY OF THE INVENTION

The present invention relates to the discovery that including a charger whose attachment is in the outside back of the phone (either the phone case back itself, or the outside back of a case) allows the cell phone user to always have charging equipment in the phone for easy charging, for regular use or in the case of an emergency.

Accordingly, in one embodiment of the invention there is a cell phone charging system comprising:

a) a cell phone having a back of the cell phone;

b) a transformer connected to a charging input on the cell phone;

c) a power cord for connecting to a power source to the transformer, the power cord accessible from the outside back of the phone.

### BRIEF DESCRIPTION OF THE DRAWINGS

FIG. 1 is a perspective exploded view of a cell phone, cell phone cover back and cover.

FIG. 2 is a perspective view of the present invention in a cell phone back.

### DETAILED DESCRIPTION OF THE INVENTION

While this invention is susceptible to embodiment in many different forms, there is shown in the drawings, and will herein be described in detail, specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### DEFINITIONS

The terms “about” and “essentially” mean ±10 percent.

The terms “a” or “an”, as used herein, are defined as one or as more than one.

The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

References throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitations thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein the term “cell phone charging system” refers to a device when used with a cell phone that is capable of charging the cell phone batteries. Cell phones are battery operated and discharge over time, leading to the need to recharge as necessary. While such systems are well known in the art, the particular system of the present invention relates to a charging system that is built into the outside of the back cover of the phone, or into the back outside surface of a cell phone cover. Cell phone covers are well known, and cover the back and sides of a cell phone to protect it from damage, such as the damage caused by dropping the phone. This cell phone charging system is designed to be a part of the cell phone, so that if you have your phone with you, you have your cell phone charging system with you. It can be an add-on system, where it is in the case or in the back cover (usually the battery cover), it could be a stock item (comes with the phone), or be a replacement back cover. This system means no matter what you do or where you go, the charging system is with the cell phone.

As used herein the term “cell phone” or “mobile phone” refers to a phone that can make and receive telephone calls over a radio link while moving around a wide geographic area. It does so by connecting to a cellular network provided by a mobile phone operator, allowing access to the public telephone network. By contrast, a cordless telephone is used only within the short range of a single, private base station. In addition to telephony, modern mobile phones also support a wide variety of other services such as text messaging, MMS, email, Internet access, short-range wireless communications (infrared, Bluetooth), business applications, gaming, and photography. Mobile phones that offer these and more general computing capabilities are referred to as smartphones.

As used herein, the term “outside back of the cell phone” refers to one of two things. First, it refers to the back cover of a cell phone, especially smartphones, where there is a cover and underneath the cover is the battery. This cover forms most, or all, of the back of the phone. It has an inside surface facing the battery and interior of the phone, and it has an outside surface which faces away from the phone (i.e. towards the environment or towards the user as the user faces the back of the cell phone).

As used herein, the term “transformer” refers to a device for converting either battery voltage (e.g. 6 or 12 volt in motor vehicles) or AC current (e.g. 120 or 240 volt in the US, and similar voltages in other countries) to a current (volts) and amperage (amps) sufficient to charge the batteries inside a cell phone (e.g. many utilize a 3.7 volt battery). Because this transformer is being used in the back cover of the cell phone, or in a cell phone cover, it should be as thin as possible to keep the cell phone as thin as possible. Wherein the connector is in the back of the cell phone. In OEM (original equipment manufacturer) condition, the transformer may be inside the phone itself or in the back cover for easy replacement. Where the device is in a cell phone cover, the transformer would be located anywhere in the cover (and not necessarily in the back of the cover since general access is not necessary). Transformers in general have an input from a power source, then some connection to the power input, then a connection to a charging input for the batteries. Where the transformer is OEM, the connection to the charging input can be hardwired or can use the standard plug-in charging input on the phone. Where the transformer is in the cell phone case there would be a cord for connecting to the standard charging input on the phone, like any other charger.

As used herein, the term “charging input” refers to the wires that connect to the cell phone batteries for inputting recharging power charge to the batteries. This can be the standard power connector on the cell phone (now usually at the bottom of most cell phones) or can be a hard wire into the charging input.

As used herein, the term “power cord” refers to the connector between the transformer and the power source used to charge the cell phone. The power cord can be an AC plug (US or various world-wide 2, 3 and 4 prong devices). They can be as flat as possible and, in one embodiment, there are prongs which twist to allow for a more flat plug, as known in the art. The power cord can be power clips or the like and, in one embodiment, it is a so-called cigarette lighter adaptor plug for use in a car. In a further embodiment, it is known in the art to make relatively flat cigarette lighter plugs, which would be useful in fitting into the back of the cell phone panel or case. In another embodiment, the cord has a USB connector or other style of connector for receiving a power charge to the cell phone from another electronic device. The power cord must be accessible from the outside back of the cell phone. This means the user doesn't have to open the phone case or the like and can just turn over the phone and access the appropriate plug to charge the phone. The phone can have more than one power cord or have multiple connectors for attaching to the power cord as desired. The power cord is positioned to lay as flat as possible, for example coiled in or on the back of the phone back or phone case. It can be an auto retractable cord or one that is manually placed in the back. The cord can be as short or as long as desired, but those are competing features. That is, a short cord takes up less room and weighs less, but might have difficulty reaching certain power sources (e.g. a high AC outlet). While a longer power cord will reach more, it also weighs more and is harder to fit in the phone case. One skilled in the art can easily decide on the most advantageous cord based on experience and the particular use for the cord, as well as other issues.

As used herein, the term “power source” refers to an AC or DC battery source utilized to charge a cell phone. These are well known in the art. As used herein, the term “antenna signal booster” refers to a device that enhances the signal received by a cell phone. In one embodiment, it is a flat extra antenna type device. These devices are well known in the art.

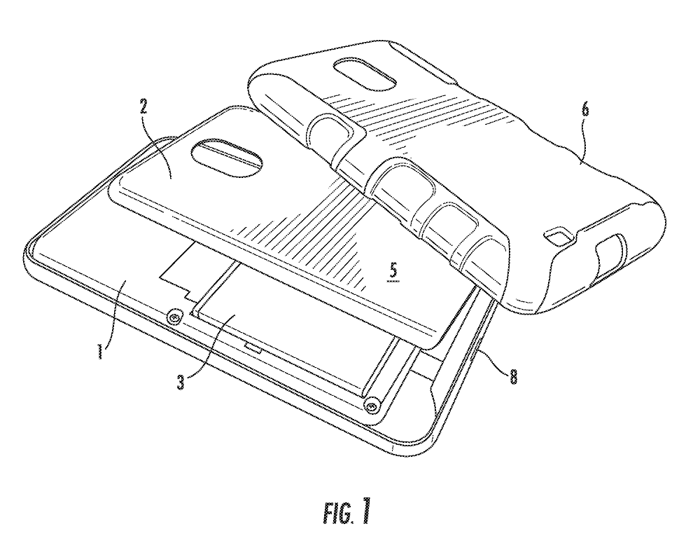

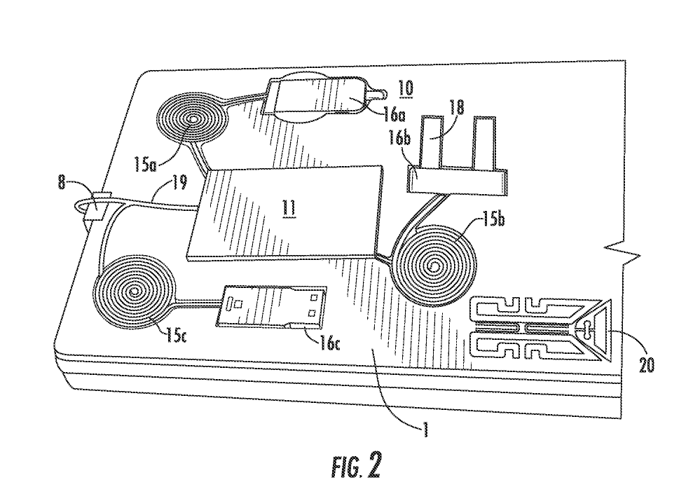

Now referring to the drawings, FIG. 1 is an exploded perspective view of a smartphone and a back cover. In this view, cell phone 1 has the back cover 2 removed so that one can see the battery 3. The cell phone can contain the transformer (shown in next figure) or it can be in the cell phone case, as shown in FIG. 2. The back cover has an outside back of the phone 5 where, if there is no cover, the power cord and, optionally, the transformer can be either hard wired or plug connected. FIG. 1 also shows a cell phone cover 6 having an outside back of phone 5 which when the cell phone cover 6 is being used is the most outside part of the phone 1. The transformer 11 shown in FIG. 2 is connected to the power input 8, or to the wires of power input 8 anywhere in line with the battery 3.

FIG. 2 is a perspective view of the cell phone 1 showing the outside back of the cell phone 10 (either the cell phone case 6 or the cell phone back 5). In this view there is a transformer 11. Transformer 11 is shown in the back 10, but where applicable can be inside the phone or elsewhere in the case. While in some embodiments there is only one cord for connecting to a power source and transformer, this view shows three power cords: 15a, 15b, and 15c, each having connectors—car charger 16a, AC plug 16b, and USB connector 16c, respectively. The power cords are all shown as coiled by hand, but could be retractable or mounted any way as desired. The car charger plug 16a is shown as the flat version, but the plug could be a standard round cylindrical type as well, though those take up more room. The AC plug 16b is shown as a thin version with prongs 18 which twist flat for storage, and perpendicular for AC use. 16c is a USB connector for connecting to the power source for the USB powered device. The transformer 11 uses cord 19 to connect to power input 8 on the phone. Then, when in use, one of the two power cords is selected right off the back of the phone and plugged in for charging, and then coiled back up after use. The present invention guarantees a charging system will always be with the phone during use. Also shown is a flat cell phone antenna signal booster 20, which is used to boost signal and help prevent dropped calls or poor reception.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A cell phone charging system comprising:
a) a cell phone having a back of the cell phone;
b) a transformer connected to a charging input on the cell phone;
c) a power cord for connecting to a power source to the transformer, the power cord accessible from the outside back of the phone.

2. The cell phone charging system according to claim 1 wherein the back of the cell phone is the outside surface of a back panel of the phone.

3. The cell phone charging system according to claim 1 wherein the back of the cell phone is the outside back surface of a cell phone case covering the back panel of the cell phone.

4. The cell phone charging system according to claim 3 wherein the transformer is contained in the cell phone case and connects to a power input of the cell phone.

5. The cell phone charging system according to claim 1 wherein the power source is an AC current power source.

6. The cell phone charging system according to claim 1 wherein the power source is a battery-powered power source.

7. The cell phone charging system according to claim 1 wherein the cord is a retractable cord.

8. The cell phone charging system according to claim 1 wherein the power cord has a flat cigarette power source connector.

9. The cell phone charging system according to claim 1 wherein the power cord has a USB connector.

10. The cell phone charging system according to claim 1 wherein there is a plurality of power connector plugs connected to the transformer.

11. The cellphone charging system according to claim 1 which further comprises a flat cell phone antenna signal booster.
